(19) United States
(12) Patent Application Publication
(10) Pub. No.: US 2021/0271704 A1
(43) Pub. Date: Sep. 2, 2021

(54) System and Method for Identifying Objects in a Composite Object

(71) Applicant: OOO ITV Group, Moscow (RU)

(72) Inventors: Egor Petrovich Suchkov, Tuapse (RU); Egor Yurevich Lvov, Moscow (RU); Vardan Taronovich Margaryan, Maykop (RU); Grigorij Olegovich Alekseenko, Irkutsk (RU)

(21) Appl. No.: 16/938,866

(22) Filed: Jul. 24, 2020

(30) Foreign Application Priority Data
Mar. 2, 2020 (RU) 2020109220

(51) Int. Cl. G06F 16/55; G06F 16/535; G06N 3/08; G06N 3/04; G06T 7/11

(52) U.S. Cl. CPC G06F 16/55; G06F 16/535; G06T 7/11; G06N 3/0454; G06N 3/08

(57) ABSTRACT

The disclosure relates to the field of applying artificial neural networks in computer vision, and more specifically to the systems and methods for processing the video data received from video cameras for automatic identification of various objects. The system for identifying the objects in the composite object comprises a graphical user interface (GUI), memory, image capture device, and data processing device. The data processing device includes a video data receipt module, an image analysis module, a segmentation module, an identification module, and an output module. The method for identifying the objects in the composite object comprises stages in which video data is received from the image capture device in real time; video data analysis is performed in order to detect a composite object in the frame; the resulting image is segmented; the object is identified using a different artificial neural network in each of the individual object images; the identification result is displayed on the screen.

### RELATED APPLICATIONS

This application claims priority to Russian Patent Application No. RU 2020109220, filed Mar. 2, 2020, which is incorporated herein by reference in its entirety.

### FIELD OF THE INVENTION

The disclosure pertains to artificial neural networks in computer vision, and more specifically to systems and methods of processing video data received from video cameras for automatic identification of various objects.

### BACKGROUND

In the context of this disclosure, video systems include hardware and software tools that use computer vision methods for automated data collection based on streaming video analysis (video analysis). Such video systems are based on algorithms of image processing, including algorithms of recognition, segmentation, classification, and identification of images, to analyze the video without direct human participation. In addition, modern video systems can automatically analyze video data from cameras and compare this data with data available in the database.

Such video systems are now available in almost all warehouses and sales outlets (mainly for security, theft prevention, and monitoring the goods and employees). A warehouse is an important structural unit, which affects the efficiency of all business processes of the enterprise or sales outlet. The increase in the volume of goods and services has made it impossible for it to operate normally on the basis of simple warehouse accounting. That is why the companies are looking for ways to automate the warehouse processes. For example, some modern warehouses are fully automated and do not require presence of a person (the goods are moved through a system of automated conveyors to the desired location and, accordingly, are also automatically shipped). Automated systems can also be used to search and trace the goods, as well as to control and record the goods in the warehouse or any other premises (see, for example, the Russian patent RU 2698157 C1).

Currently, the following common technologies for automated warehouse management are widely used: marking the cargo and goods to identify the goods and track their route; bin location storage, which guarantees order in the warehouse, since all goods are assigned a specific location address; two-dimensional barcode generation, which is necessary to optimize the warehouse logistics and allows to learn instantly all information about the goods using special software equipment; 3D-scanning, which is more typical for industrial warehouses; and RFID, a method, according to which information about the cargo or goods is recorded from RFID-tags.

For example, we know the U.S. Pat. No. 8,310,363 B2, published Nov. 13, 2012, which describes automated monitoring of inanimate objects that can be moved to or from premises. Monitoring is carried out by a system of sensors designed to be placed on at least one inanimate object that is movable relative to the asset and situated in said interior defined by said frame, said sensor system being arranged to obtain data about the at least one object other than location of the at least one object and process the obtained data to determine whether a condition about the at least one object has occurred; an event monitoring sensor coupled to said sensor system and that monitors whether an event related to movement of the at least one object relative to said frame occurs, said sensor system obtaining the data about the at least one object only when said event monitoring sensor detects occurrence of the event; a location determining system arranged to monitor the location of the asset; and a communication system coupled to said sensor system and said location determining system, said communication system transmitting the determination of whether the condition about the at least one object has occurred by said sensor system and the location of the asset provided by said location determining system to a remote facility whenever said sensor system obtains data about the at least one object as a result of detection of the occurrence of the event by said event monitoring sensor, wherein the remote facility can take appropriate action.

We also know the Chinese patent application CN 102147888 A, published Aug. 10, 2011, which describes a smart warehouse management system that includes a data processing device, RFID storage, and RFID tray. RFID storage and RFID tray are respectively equipped with electronic RFID tags. The RFID tray is wirelessly connected to data processing equipment. The system is distinguished by the fact that it also includes a manual warehouse manager's terminal, a vehicle terminal, a forklift truck terminal, and a gate terminal mounted at the warehouse door. This disclosure also describes a method applied to this smart warehouse management system, which implements smart warehouse management using electronic RFID tags.

To implement the solutions described above, each facility in a warehouse or any other protected area should be equipped with either an appropriate sensor or an RFID tag that is read by different RFID readers to track the objects. Such solutions are complex and expensive to implement. In addition, there is a high probability of error in their implementation.

From the background of the disclosure, we also know the solution disclosed in the application US 20130088591 A1, published Apr. 11, 2013, which describes the system for identifying and tracking the objects, configured to associate the object's ID with the object's position in the warehouse, wherein the system comprises a number of pairs of video cameras and a processing means connected to the pairs of video cameras, the processing means being configured to: determine an object identity for said object, determine a first position for said object based on images from said pairs of video cameras and to associate said object identity with said first position. Although the disclosure uses video data and image processing methods, it differs significantly from the present disclosure.

One important difference/advantage of the present disclosure compared the disclosure known from the pertinent background is the use of available standard video surveillance and image processing tools to identify objects/products in the warehouse. It is primarily aimed at simplification, acceleration, and identification process accuracy improvement. In addition, when an order or delivery is formed, the goods are usually placed on special pallets or trays. It involves the recognition and identification of individual objects within a single composite object. No separate identification of each object is required (as in the case with tagging and barcode technologies). This approach also speeds up the identification process.

In addition, the state-of-the-art video systems increasingly use artificial neural networks to recognize and identify images. An artificial neural network (ANN) is a mathematical model and its hardware and/or software implementation, built on the principles of organization and functioning of biological neural networks (networks of nerve cells of living organisms). One of the main advantages of an ANN is the possibility of its training, in the process of which the ANN can independently detect complex dependencies between input and output data. The use of one or even several ANNs for image processing, as well as the use of standard video surveillance and video data processing tools make the claimed solution easier to implement in absolutely any premise and more accurate in terms of object identification (including composite objects) compared to the solutions known from the background of the disclosure.

### BRIEF SUMMARY

This technical solution is aimed to eliminate the disadvantages of the previous background of the disclosure and develop the existing solutions.

The technical result of the claimed group of disclosures is to improve the accuracy and speed of object identification through the use of at least one artificial neural network.

This technical result is achieved by a system for identifying the objects in a composite object comprising the following components: graphical user interface (GUI) comprising the data input and output tools configured to provide user interaction with the system; memory configured to store video data and database, which includes at least sample reference images of the objects; at least one image capture device configured to obtain video data from the control area; and at least one data processing device comprising: video data acquisition module configured to receive video data from at least one real-time image capture device; image analysis module configured to analyze the video data for the purpose of detecting at least one composite object in the frame, whereupon the resulting image is sent to the segmentation module; segmentation module configured to segment the resulting composite object image into individual images of objects that are part of the composite object, wherein the mentioned segmentation is implemented using an artificial neural network (ANN); identification module configured to identify the objects using at least one artificial neural network on each of the resulting individual object images; output module for displaying the identification results.

The specified technical result is also achieved by the method for identifying the objects in a composite object performed by a computer system comprising a graphical user interface, at least one data processing device, and a memory storing video data and database, which includes at least a sample of reference object images, wherein the method comprises the stages at which the following operations are executed: receipt of video data from at least one real-time image capture device, wherein the mentioned image capture device received the video data from the control area; video data analysis for the purpose of detecting at least one composite object in the frame and retrieving the image of the composite object; segmentation of the resulting image of the composite object into individual images of objects that are part of the composite object, wherein the mentioned segmentation is carried out with the use of the artificial neural network (ANN); identification of the object using at least one artificial neural network on each of the selected object images; display of the identification results on the screen.

In one example embodiment, the composite objects include at least the following: pallets, trays, and objects that are part of a composite object include at least the following: cargo, goods, box.

In another example embodiment, the control areas include at least one of the following: a warehouse, a car body.

In another example embodiment, the segmentation is done by color and/or shape and/or texture.

In another example embodiment, the identification is performed by comparing each recognized image of an object with at least one reference object image stored in the database.

In another example embodiment, all objects in the database are divided into the object classes.

In another example embodiment, each class of the objects has a separate ANN used for identification purposes.

In another example embodiment, at least one data processing device additionally comprises a classification module configured to classify the individual object images after segmentation of separate objects into classes, wherein this classification process involves the use of a separate artificial neural network.

In another example embodiment, the system is additionally configured to automatically replenish the sample of reference images of each object for training of at least one artificial neural network, wherein replenishment of sample of reference images and training of at least one artificial neural network are continuous processes, because the set of objects and their appearance changes with time.

In another example embodiment, the sample of reference images of each object comprises N last uploaded images for this object, where N is a positive integer preset by the user.

In another example embodiment, at least one data processing unit additionally comprises an accounting and control module configured for counting both composite objects and identified objects that are part of a composite object for the purpose of counting the objects in each user-defined control area at a time set by the system user.

In another example embodiment, the accounting and control module is additionally configured to count the objects that left the control area and arrived at the control area.

In another example embodiment, the accounting and control module is additionally configured to compare the number of departed identified objects from one control area to the number of identified objects that have arrived in at least one other control area, wherein the compared control areas are defined by the system user, and the output module automatically performs the actions preset by the system user whenever a discrepancy is detected.

In another example embodiment, the actions preset by the system user include at least one or a combination of the following: alarm initiation, SMS notification of the system user, e-mail notification of the user, and audio notification of the user.

In another example embodiment, the accounting and control module, in case of detection of discrepancy of the mentioned number of identified objects in the different control areas, additionally performs identification of at least one time interval during which the violation might have occurred, whereupon the output module automatically exports the video data of this time interval and sends it to the preset user of the system for analysis.

In another example embodiment, the output module is additionally configured to automatically record the processed video data into an archive and/or export the video data, wherein recording and exporting can be performed either for all video data in the time interval set by the system user or only for those video data, in which the facts of departure and arrival of objects to each control area have been recorded, to provide the possibility of analysis on the basis of archive data.

In another example embodiment, the accounting and control module is additionally configured with the possibility to generate a report based on the results of identification, counting, and comparison of the number of identified objects, wherein the report can be generated for each control area separately or for a bunch of control areas, with the mentioned bunch of control areas either preset by the user or set by the system user in real time.

In another example embodiment, the output module is additionally configured to display at least one report on the screen or send at least one resulting report to a preset system user.

In another example embodiment, the video data analysis for the purpose of detecting at least one composite object in the frame is performed continuously or within a time range specified by the system user, or upon the command of the system user.

In addition to the above, this technical result is also achieved by a computer-readable data carrier comprising instructions executable by the computer's processor to implement the methods for identifying the objects in the composite object.

### BRIEF DESCRIPTION OF THE SEVERAL VIEWS OF THE DRAWINGS

FIG. 1 is a block diagram of the system for identifying objects in a composite object.

FIG. 2 is a block diagram of one of the embodiments of the method for identifying the objects in a composite object.

### DETAILED DESCRIPTION

Description of example embodiments of the disclosure is presented below. However, the disclosure is not limited only to these embodiments. It will be obvious to persons who are experienced in this field that other embodiments may fall within the scope of the disclosure and claims.

The solution in its various embodiment options can be implemented in the form of computing systems and methods implemented by various computer devices, as well as in the form of a computer-readable data carrier, which stores instructions executed by the computer processor.

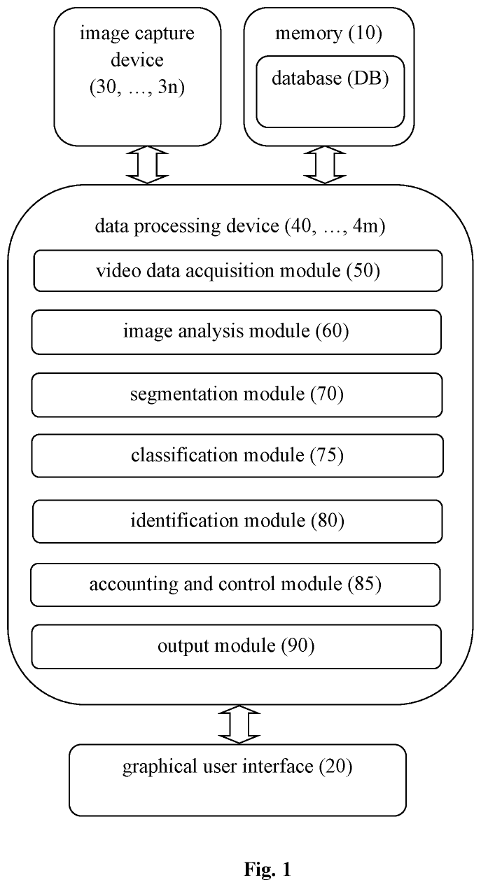

FIG. 1 shows a block diagram of the system for identifying the objects in a composite object. This system, in its complete set, includes the following components: a memory (10) configured to store the database (DB) and video data; a graphical user interface (20) comprising data input/output devices; at least one image capture device (30, . . . , 3n); and at least one data processing device (40, . . . , 4m) comprising: video data receipt module (50), image analysis module (60), segmentation module (70), classification module (75), identification module (80), accounting and control module (85), and output module (90). It should be mentioned that the basic system may not include modules (75) and (85).

In this context, computer systems may be any hardware- and software-based interconnected technical tools.

In the context of this disclosure, an image capture device may be a video camera.

The data processing device may be a processor, microprocessor, computer, PLC (programmable logic controller) or integrated circuit, configured to execute certain commands (instructions, programs) for data processing. The processor can be multi-core, for parallel data processing.

The graphical user interface (GUI) is a system of tools for user interaction with the computing device based on displaying all system objects and functions available to the user in the form of graphical screen components (windows, icons, menus, buttons, lists, etc.). Thus, the user has random access via data input/output devices to all visible screen objects—interface units—which are displayed on the display. The data input/output device can be, but is not limited to, mouse, keyboard, touchpad, stylus, joystick, trackpad, etc.

Memory devices may include, but are not limited to, hard disk drives (HDDs), flash memory, ROMs (read-only memory), solid state drives (SSDs), optical drives, etc.

In the context of this application, the memory stores video data from image capture devices as well as a database (DB) that includes at least a sample of reference object images.

It should be noted that the described system may also include any other devices known in the background of the disclosure, such as sensors of various types, data input/output devices, display devices, label or bar code readers, etc.

An example of how the above system works to identify the objects in a composite object will be described in detail below.

All stages of system operation described below are also applicable to the implementation of the claimed method for identifying the objects in a composite object, which will be discussed in more detail below.

Let's consider a principle of work of the given system. Let's assume the given system and the corresponding software are installed in a warehouse of a large store. Trucks (for the large-sized goods) or cars (for small cargoes and the goods) are used to deliver and transport the goods to a warehouse from the supplier or to the buyers.

Storage premise as well as the body of each car is equipped with image capture devices (30, . . . , 3n). The image capture device, in this case a video camera, is positioned in such a way to ensure continuous receipt of real-time video data from a certain control area. In the context of this application, control areas shall include at least one of the following: a warehouse, a truck body, a car body, or any other premise used for storing or transporting various goods (objects).

It should be noted that the described identification system may include several cameras in each individual control area in order to receive obtain more video data and improve the accuracy of results. Image capture devices continuously receive real-time video data, which is recorded into the surveillance system archive (to enable further analysis on the basis of the archive data) and also sent to the data processing device.

Further, at least one data processing device, such as a computer graphics processor, performs the main work. The mentioned data processing device (40, . . . , 4m) includes individual software or hardware modules/units, each of which is configured to perform a specific task. In the described solution, as shown in FIG. 1, the data processing device comprises the following modules: video receipt module (50), image analysis module (60), segmentation module (70), classification module (75), identification module (80), accounting and control module (85), and output module (90). The operation of each module will be described in detail below.

The video data receipt module (50) continuously receives all video data from at least one real-time image capture device. All video data received is then analyzed by the image analysis module (60) to identify/discover the frames that display/characterize at least one composite object, whereupon the resulting image is sent to the segmentation module (70).

In the context of this application, the composite objects include at least the following: pallets, trays (to put it simply, the containers where several objects can be placed), while the objects that are part of a composite object include, without limitation, cargo, goods, box, product, and so on. Thus, as stated in the particular embodiment of the system, the video data analysis is performed continuously or within a time range set by the system user, or upon a signal/command from the system user. That is, for the warehouse that ships and receives the goods, for example, from 8:00 to 12:00, it would be appropriate to record and analyze the video data only in this time interval to save memory and computing resources of the system.

All image capture devices are located in control areas so as to fully cover the entire premise/control area. To obtain a complete picture of the control area, the camera view areas may slightly overlap/overlay. The image analysis module can easily detect all composite or individual objects. Once a frame with a composite object is detected, the image/frame of at least one such composite object is automatically sent to the segmentation module (70).

The segmentation module (70) is configured to segment the resulting image of the composite object into individual images of objects that are part of the composite object. The mentioned segmentation is performed using artificial neural network. It should be mentioned that segmentation can be performed by color and/or shape and/or texture. The system user can either set any type of segmentation or perform the segmentation sequentially by each of the listed methods.

After dividing the image of the composite object into separate images of its constituent objects, these separate images are then sent to the identification module (80). The mentioned module performs identification of objects using at least one artificial neural network for each of the resulting separate object images. Identification is performed by comparing each recognized object image with at least one object image stored in the database. If, in the process of identification, the recognized object image matches sufficiently with at least one image from the database, the system immediately stops the identification process. This approach allows not to waste available computing resources of the system and speeds up the comparison process.

The identification principle is as follows: the artificial neural network receives a separate object image, whereupon it generates some number vector—image descriptor. The database stores a sample of reference images of all objects, including descriptors corresponding to each image. ANN sues these descriptors to compare the images. Moreover, the ANN is trained in such a way that the smaller the angle between these number vectors in space, the more likely it is that the images will match. The angle cosine between the number vectors (vectors from the database and the resulting object image vector) is used as a metric for comparison. Accordingly, the closer the angle cosine between the vectors to one is, the higher the probability that the object on the compared pair of images is the same. When setting up the system, the user can specify the range of values, at which the system will decide on matching of the objects. In this case, the artificial neural network compares sequentially every image of the object with all images of objects in the database until it gets a sufficient match.

To increase the system operation accuracy and speed up and improve the object identification, classification of separate object images can be carried out before direct identification in some embodiments of the claimed solution. For this purpose, at least one data processing device has an additional classification module (75), using a separate/its own ANN for classification. The mentioned classification module is configured with the possibility of classifying individual object images resulting after the segmentation by object classes. Examples of such classes may be, but are not limited to: electronics, household appliances, pet products, children's goods, household goods, clothing, car accessories, goods for the garden, construction, sports, health, foodstuff, and so on. In addition, objects in each class can be further divided into more specific subclasses (for example, foodstuff can be divided into such subclasses as: tea, coffee, spirits, confectionery, bakery, grocery, canned food, beverage, dairy products, etc., up to distribution into such subclasses as: box, bag, bottle, short shelf-life food, etc.). Thus, all object files in the database are also divided into similar classes (available in a particular warehouse, where the identification system under consideration is used). Data on each object in the database include at least: name, basic characteristics (such as size, shape, color) and a sample of the object reference images. Thus, each image in the sample of the object reference images includes the descriptor characterizing a number vector of the given image. It should be mentioned that the identification module has separate ANN for each object class (or even subclass) used to identify the objects (to improve the identification accuracy and speed).

As for the sample of the object reference images, the identification system under consideration is configured to automatically replenish the mentioned sample of the reference images for each object to train at least one artificial neural network used. Thus, the replenishment of the object reference image sample and training of at least one artificial neural network are continuous processes, because the set of objects and their appearance change with time. It should be mentioned that the processes of image sample replenishment, artificial neural network training, and direct image processing can be performed simultaneously by at least one data processing device. Thus, each new image of the object is added to the sample of reference images of the corresponding object only after the process of identifying this image has been completed (to avoid errors).

In the context of the claimed solution, training of each artificial neural network is carried out on the basis of the replenished database. The system user/operator can specify a certain time at which training of the artificial neural network will be carried out. For example, once a day. In this case, the mentioned training can be performed, for example, by a data processing device or a cloud service, or any other computing device.

It should be noted once again that the sample of images of each object comprises multiple images of this object (different angles and types). When setting up the system, the user can specify a certain number of images to be comprised in the sample (to keep the data in the database up-to-date). Thus, the sample of reference images of each object comprises N last uploaded images for this object, where N is a positive integer number preset by the user. Let's suppose that the user has set N=20. After identifying a particular object (e.g., a printer of a certain brand and model has been identified), the data processing unit analyzes the sample of images for that particular printer. If the number of images in the image sampling for the identified object is 20, the data processing unit deletes the oldest image and saves the newest, just received image of the object in the sample. If the sample of images comprises, for example, only 5 images of the object, the newly received image of the object is simply added to the sample (without deleting the older images). In this way, it is possible to keep the information about the objects in stock up-to-date. This is necessary because the set of objects/goods and their appearance change over time.

Once all objects are identified, different system embodiments perform different actions, according to the requirements at different enterprises or sales outlets. In the basic embodiment, the object identification results are sent to the output module (90), which is configured to display the received identification results on the screen. The obtained results can be used either by the system user or can be uploaded to any other data processing system for analysis and further processing.

However, most often, this kind of identification systems are used for complete accounting and control of goods in the warehouse. For this purpose, the data processing device of the claimed system has a separate counting and control module (85). This module is configured to count both composite objects and identified individual objects that are part of a composite object in a certain user-defined control area. It should be noted that any user interaction with the system is carried out through the use of data input/output tools comprised in the GUI (Graphical User Interface) of the claimed identification system. The mentioned counting of objects is necessary for accounting of objects at a time set by the system user in each user-defined control area. Thus, the accounting and control module is additionally configured to count the objects that left the control area and arrived at the control area. This allows the user to easily monitor how many objects (goods) have been taken from the warehouse, how many have been loaded to the truck for transportation, how many have been brought to the warehouse, and so on.

Besides, the accounting and control module (85) is additionally configured to compare the number of departed identified items from one control area with the number of arrived identified items in at least one other control area. In this case, the compared control areas are defined by the system user (by GUI tools) and if a discrepancy of the mentioned quantity is detected, the output module (90) automatically performs the actions preset by the system user. For example, let's consider the situation when a set of goods was taken from the warehouse for delivery to the buyer. In this case, the first control area is the warehouse; the second control area is the truck by which the goods are supposed to be delivered to the buyer. If the identification system has determined that 9 items of goods have left the warehouse at a certain time and 9 items of goods have been loaded into the truck, the system does not perform any actions. However, if 9 items have left the warehouse and only 7 items have arrived to the truck, the system performs actions preset by the user. Thus, in the context of this application, the actions preset by the system user include at least one or a combination of the following operations: alarm initiation, SMS notification of the system user, e-mail notification of the user, audio notification of the user, etc. In this way it is possible to detect an error in time and to eliminate it in the warehouse without involving the end buyer of the set of goods in this process. It should be noted that the considered case is the simplest.

Usually, a very large number of goods, which are carried by different customers in different cars, leave the warehouse every day. In this case, the number of items leaving the warehouse (from area 1) can be compared with the total number of items arriving to the truck systems preset by the user (area 2+area 3+area 4+ . . . ).

In addition, in some embodiments of the system, the accounting and control module (85), in case of discrepancy of the mentioned number of identified objects in different control areas, additionally determines at least one time interval during which the violation potentially might have occurred. Once the mentioned time interval is determined, the output module automatically exports the video data of this time interval and sends it to a preset system user for analysis. In other words, the system user can view the video data of only one time interval defined by the system and easily understand where the error or violation occurred (without wasting a lot of time).

As it was mentioned before, the output module (90) in its basic implementation is configured to display the identification results, but the mentioned module is also additionally configured to automatically record the processed video data into archive and/or export the mentioned video data. Moreover, recording and export can be performed for all video data of the user-defined time interval or only for those video data, in which the facts of departure and arrival of objects to each control area are recorded. This is necessary to ensure the ability to quickly and accurately analyze the video data based on the archive data.

Besides, as for the accounting and control module (85), it is additionally configured with the possibility to draw up a report based on the results of identification, counting, and comparing the number of identified objects. It should be noted that the mentioned report can be generated for each control area separately or for a bunch of control areas, which is either preset by the user or set by the system user in real time (using GUI tools). For example, for a bunch of control areas, such as several trucks, which were taking the goods from the warehouse during the day.

The output module (90) is additionally configured to display at least one resulting report on the screen. These reports are generated either upon receipt of a signal from the user or at a time preset by the user (for example, once a day, at 21:00, after the end of shipments from the warehouse). In addition, the reports can be automatically sent to preset users of the system (for example, by SMS or e-mail) or saved in the system memory. However, if at least one report is generated upon a signal/command from the system user, this report can be immediately displayed by the output module (90).

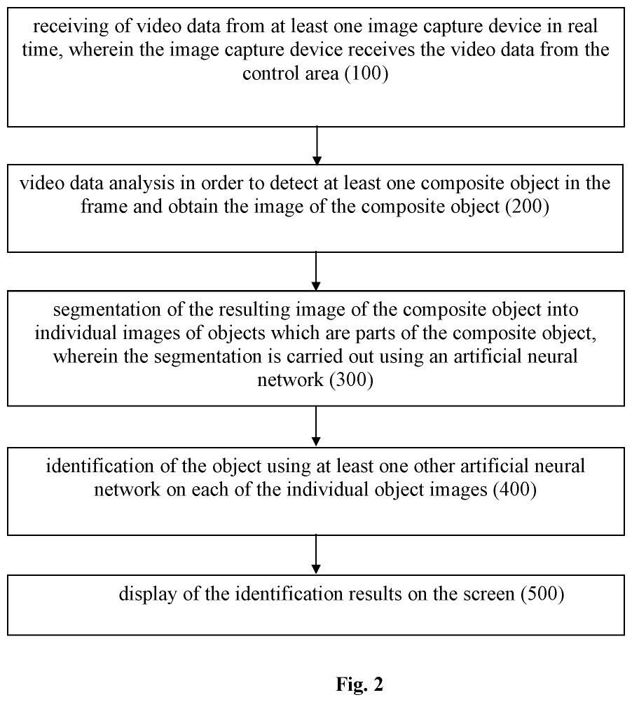

An example of specific implementation of the method for identifying the objects in the composite object will be described below. FIG. 2 shows a block diagram of one of the options for implementing the method for identifying the objects in the composite object.

This method is performed by the computer system described above, which comprises a graphical user interface, at least one data processing device, and memory, storing video data and a database that includes at least a sample of the object reference images.

The claimed method in its basic version comprises the stages, at which the following operations are executed:

(100) receipt of the video data from at least one image capture device in real time, wherein the said image capture device receives the video data from the control area;

(200) video data analysis in order to detect at least one composite object in the frame and obtain the image of the composite object;

(300) segmentation of the resulting image of the composite object into individual images of objects that are part of the composite object, wherein the segmentation is carried out using the artificial neural network (ANN);

(400) identification of the object using at least one other artificial neural network on each of the individual object images;

(500) display of the identification result on the screen.

It should be noted once again that this method can be implemented using of the above-mentioned computer system and, consequently, can be extended and refined by all embodiments of the system that have already been described above to implement the system for identifying the objects in the composite object.

Besides, the embodiment options of this group of disclosures can be implemented with the use of software, hardware, software logic, or their combination. In this implementation example, software logic, or instruction set is stored on one or more of the different traditional computer-readable data media.

In the context of this description, a computer-readable data carrier may be any environment or medium that can contain, store, transmit, distribute, or transport the instructions (commands) for their application (execution) by a computer device, such as a personal computer. Thus, a data carrier may be an energy-independent machine-readable data carrier.

If necessary, at least some part of the various operations presented in the description of this solution can be performed in an order differing from the described one and/or simultaneously with each other.

Although the technical solution has been described in detail to illustrate the most currently required and preferred embodiments, it should be understood that the disclosure is not limited to the embodiments disclosed and, moreover, is intended to modify and combine various other features of the embodiments described. For example, it should be understood that this disclosure implies that, to the possible extent, one or more features of any embodiment option may be combined with one or more other features of any other embodiment option.

1. A system for identifying the objects in a composite object comprising:
graphical user interface (GUI) comprising data I/O tools configured to provide user interaction with the system;
memory configured for storage of video data and database, which includes at least a sample of the object reference images;
at least one image capture device configured to obtain video data from the control area; and
at least one data processing device, comprising:
to a video data receipt module configured to continuously receive all video data from at least one real-time image capture device;
an image analysis module configured to analyze the video data in order to detect at least one composite object in the frame, whereupon the resulting image is sent to the segmentation module;
a segmentation module configured for segmentation of the resulting image of the composite object into individual images of objects that are part of the composite object, wherein the segmentation is carried out using the artificial neural network (ANN);
identification module configured to identify the objects using at least one artificial neural network for each of the resulting separate object images;
output module configured to display the identification result.

2. The system according to claim 1, in which the composite objects include at least the following: pallets, trays, and objects that are part of a composite object include at least the following: cargo, goods, box.

3. The system according to claim 1, wherein the control areas include at least one of the following: storage room, car body.

4. The system according to claim 1, wherein the segmentation is performed by color and/or shape and/or texture.

5. The system according to claim 4, wherein the identification is carried out by comparing each recognized object image with at least one reference image of the objects stored in the database.

6. The system according to claim 1, wherein the all objects in the database are divided into the object classes.

7. The system according to claim 6, wherein a separate ANN used in identification is provided for each object class.

8. The system according to claim 7, wherein the at least one data processing device additionally comprises a classification module configured to classify the individual object images after segmentation of separate objects into classes, wherein this classification process involves the use of a separate artificial neural network.

9. The system according to claim 1, wherein the additionally configured to automatically replenish the sample of reference images of each object for training at least one artificial neural network,
wherein, the replenishment of the object reference image sample and training of at least one artificial neural network are continuous processes, because the set of objects and their appearance change with time.

10. The system according to claim 9, wherein the sample of reference images of each object comprises N last uploaded images for this object, where N is a positive integer number preset by the user.

11. The system according to claim 1, wherein the at least one data processing unit additionally comprises an accounting and control module configured for counting both composite objects and identified objects that are part of a composite object for the purpose of counting the objects in each user-defined control area at a time set by the system user.

12. The system according to claim 11, wherein the accounting and control module is additionally configured to count the objects that left the control area and arrived at the control area.

13. The system according to claim 12, wherein the accounting and control module is additionally configured to compare the number of identified objects that left from one control area to the number of identified objects that have arrived in at least one other control area, wherein the compared control areas are defined by the system user, and the output module automatically performs the actions preset by the system user whenever a discrepancy is detected.

14. The system according to claim 13, wherein the actions preset by the system user include at least one or a combination of the following: alarm initiation, SMS notification of the system user, e-mail notification of the user, and audio notification of the user.

15. The system according to claim 13, wherein the accounting and control module, in case of detection of discrepancy of the mentioned number of identified objects in the different control areas, additionally performs identification of at least one time interval during which the violation might have occurred, whereupon the output module automatically exports the video data of this time interval and sends it to the preset user of the system for analysis.

16. The system according to claim 1, wherein the output module is additionally configured to automatically record the processed video data into an archive and/or export the video data, wherein recording and exporting can be performed either for all video data in the time interval set by the system user or only for those video data, in which the facts of leaving and arrival of objects to each control area have been recorded, to provide the possibility of analysis on the basis of archive data.

17. The system according to claim 11, wherein the accounting and control module is additionally configured with the possibility to generate a report based on the results of identification, counting, and comparison of the number of identified objects, wherein the report can be generated for each control area separately or for a bunch of control areas, with the mentioned bunch of control areas either preset by the user or set by the system user in real time.

18. The system according to claim 17, wherein the output module is additionally configured to display at least one report on the screen or send at least one resulting report to a preset system user.

19. The system according to claim 1, wherein the video data analysis for the purpose of detecting at least one composite object in the frame is performed continuously or within a time range specified by the system user, or upon the command of the system user.

20. Method for identifying the objects in the composite object performed by a computer system comprising a graphical user interface, at least one data processing device, and memory storing video data and database, which includes at least a sample of the object reference images, wherein the method comprises the stages at which the following operations are performed:
receipt of the video data from at least one image capture device in real time, wherein the image capture device receives the video data from the control area;
video data analysis in order to detect at least one composite object in the frame and obtain the image of the composite object;
segmentation of the resulting image of the composite object into individual images of objects that are part of the composite object, wherein the segmentation is carried out using the artificial neural network (ANN);
identification of the object using at least one other artificial neural network on each of the individual object images;
display of the identification result on the screen.

21. A method according to claim 20, wherein the composite objects include at least the following: pallets, trays, and objects that are part of a composite object include at least the following: cargo, goods, box.

22. The method according to claim 20, wherein the control areas include at least one of the following: storage room, car body.

23. Method according to claim 20, wherein the segmentation is performed by color and/or shape and/or texture.

24. The method according to claim 23, wherein the identification is carried out by comparing each recognized object image with at least one reference image of the objects stored in the database.

25. The method according to claim 20, wherein the all objects in the database are divided into the object classes.

26. The method according to claim 25, wherein a separate ANN used in identification is provided for each object class.

27. The method according to claim 26, wherein the additionally configured with the possibility of classifying individual object images resulting after the segmentation by object classes, wherein this classification process involves the use of a separate artificial neural network.

28. The method according to claim 20, wherein the reference image sample of each object is automatically replenished for training of at least one artificial neural network, wherein, the replenishment of the object reference image sample and training of at least one artificial neural network are continuous processes, because the set of objects and their appearance change with time.

29. The method according to claim 28, wherein the sample of reference images of each object comprises N last uploaded images for this object, where N is a positive integer number preset by the user.

30. The method according to claim 20, wherein the additionally comprises the accounting and control stage, at which both composite objects and identified objects that are part of the composite objects in the specified control area are counted in each user-defined control area at a user-defined time after the identification stage.

31. The method according to claim 30, wherein the objects that have left the control area and arrived to the control area are additionally counted at the stage of accounting and control.

32. The method according to claim 31, wherein the accounting and control module is additionally configured to compare the number of identified objects that have left from one control area to the number of identified objects that have arrived in at least one other control area, wherein the compared control areas are defined by the system user, and the output module automatically performs the actions preset by the system user whenever a discrepancy is detected.

33. The method according to claim 32, wherein the actions preset by the system user include at least one or a combination of the following: alarm initiation, SMS notification of the system user, e-mail notification of the user, and audio notification of the user.

34. The method according to claim 32, wherein the accounting and control module, in case of detection of discrepancy of the mentioned number of identified objects in the different control areas, additionally performs identification of at least one time interval during which the violation might have occurred, whereupon the output module automatically exports the video data of this time interval and sends it to the preset user of the system for analysis.

35. The method according to claim 20, wherein the output module is additionally configured to automatically record the processed video data into an archive and/or export the video data, wherein recording and exporting can be performed either for all video data in the time interval set by the system user or only for those video data, in which the facts of leaving and arrival of objects to each control area have been recorded, to provide the possibility of analysis on the basis of archive data.

36. The method according to claim 31, wherein the accounting and control module is additionally configured with the possibility to generate a report based on the results of identification, counting, and comparison of the number of identified objects, wherein the report can be generated for each control area separately or for a bunch of control areas, with the mentioned bunch of control areas either preset by the user or set by the system user in real time.

37. The method according to claim 36, wherein the output module is additionally configured to display at least one report on the screen or send at least one resulting report to a preset system user.

38. The method according to claim 20, wherein the video data analysis for the purpose of detecting at least one composite object in the frame is performed continuously or within a time range specified by the system user, or upon the command of the system user.

39. A non-transitory computer-readable data media comprising instructions executed by the computer processor for implementation of methods for identifying the objects in the composite object according to claim 20.
